(19) United States
(12) Patent Application Publication
(10) Pub. No.: US 2009/0002566 A1
(43) Pub. Date: Jan. 1, 2009

(54) IMAGE PROCESSING APPARATUS, TV APPARATUS AND IMAGE PROCESSING METHOD

(75) Inventor: Kenichi NAGAI, Isesaki-shi (JP)

Correspondence Address: PATTERSON & SHERIDAN, L.L.P., 3040 POST OAK BOULEVARD, SUITE 1500, HOUSTON, TX, 77056, US

(73) Assignee: KABUSHIKI KAISHA TOSHIBA, Tokyo (JP)

(21) Appl. No.: 12/147,330

(22) Filed: Jun. 26, 2008

(30) Foreign Application Priority Data
Jun. 29, 2007 (JP) 2007-173055

(51) Int. Cl. H04N 5/57; H04N 5/66

(52) U.S. Cl. 348/687; 348/739; 348/E05.119; 348/E05.133

(57) ABSTRACT

According to one embodiment, an image processing apparatus includes a reception unit for selectively receiving a signal, a signal processing unit for processing the signal that is output from the reception unit, and outputting the signal to a display unit, and control unit for controlling the signal processing unit, wherein the control unit includes a determination unit for determining whether the display unit is powered on, and the signal processing unit includes correction unit for correcting brightness of an image, which is displayed on the display unit, for a predetermined time from when the determination unit determines that the display unit is powered on.

### CROSS-REFERENCE TO RELATED APPLICATIONS

This application is based upon and claims the benefit of priority from Japanese Patent Application No. 2007-173055, filed Jun. 29, 2007, the entire contents of which are incorporated herein by reference.

### BACKGROUND

1. Field

One embodiment of the present invention relates to an image processing apparatus, a TV apparatus and an image processing method.

2. Description of the Related Art

In general, a TV apparatus includes a display unit, a reception unit which receives a signal, a tuner which selects a signal that is received by the reception unit, a signal processing unit which processes the signal that is selected by the tuner so that the processed signal may become a signal which is suited to the display unit, and a control unit which controls the display unit and the signal processing unit.

In some cases, video and images, which are displayed on the pixels of the display unit, vary in brightness, depending on characteristics of devices which display such video and images. Conventionally, in such cases, gamma correction is executed immediately before video and images are displayed.

For example, there has been proposed a TV adjustment system which corrects non-uniformity of brightness of display due to non-uniformity among display devices (see Jpn. Pat. Appln. KOKAI Publication No. 2005-57543).

However, even if the brightness of display is corrected so as to adjust the non-uniformity among display devices, as described above, there are cases in which sufficient brightness cannot be obtained for a while after power-on of the display devices.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 schematically shows an example of the structure of a TV apparatus according to a first embodiment of the present invention;

FIG. 2 is an exemplary graph for describing an example of a correction method in a gamma correction unit of the TV apparatus shown in FIG. 1;

FIG. 3 is an exemplary graph showing an example of the relationship between an input signal to the gamma correction unit and an output signal when correction is made as shown in FIG. 2;

FIG. 4 is an exemplary view for describing another example of the correction method in the gamma correction unit of the TV apparatus shown in FIG. 1;

FIG. 5 is an exemplary view for describing still another example of the correction method in the gamma correction unit of the TV apparatus shown in FIG. 1;

FIG. 6 is an exemplary view for describing an example of an image processing method in the TV apparatus shown in FIG. 1;

FIG. 7 schematically shows an example of the structure of a TV apparatus according to a second embodiment of the present invention; and

FIG. 8 is an exemplary view for describing an example of an image processing method in the TV apparatus shown in FIG. 7.

### DETAILED DESCRIPTION

Various embodiments according to the invention will be described hereinafter with reference to the accompanying drawings. In general, according to one embodiment of the invention, there is provided an image processing apparatus includes reception means TN for selectively receiving a signal; signal processing means 10 for processing the signal that is output from the reception means TN, and outputting the signal to display means LCD; and control means CTR for controlling the signal processing means 10, wherein the control means CTR includes determination means 20 for determining whether the display means LCD is powered on, and the signal processing means 10 includes correction means 10A for correcting brightness of an image, which is displayed on the display means LCD, for a predetermined time from when the determination means 20 determines that the display means LCD is powered on.

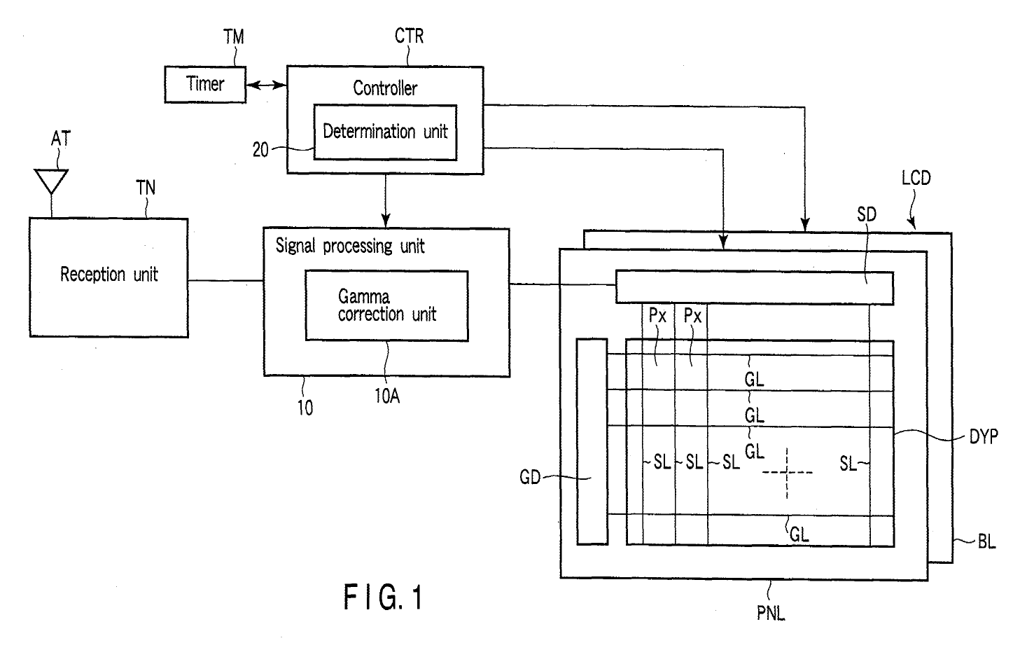

A TV apparatus according to a first embodiment of the present invention will now be described with reference to the accompanying drawings. As shown in FIG. 1, the TV apparatus according to this embodiment includes a liquid crystal display device LCD as a display unit, a reception unit TN which selectively receives a program signal, a signal processing unit 10 which processes a signal that is received by the reception unit and produces a signal that is displayable on the liquid crystal display device LCD, and a controller CTR which controls the operations of the liquid crystal display device LCD and the signal processing unit 10. The signal processing unit 10 executes a process of, e.g. decoding of a signal which is supplied from the reception unit TN, and produces a signal which can be displayable on the liquid crystal display device LCD.

The liquid crystal display device LCD includes a liquid crystal display panel PNL and a backlight BL as illumination means for illuminating the liquid crystal display panel PNL from the back side. The liquid crystal display panel PNL includes a display area DYP which is composed of matrix-arrayed display pixels PX, and a signal line driving circuit SD and a scanning line driving circuit GD which are disposed around the display area DYP.

In the display area DYP, disposed are signal lines SL extending along columns of display pixels PX, and scanning lines GL extending along rows of display pixels PX. The signal lines SL are electrically connected to the signal line driving circuit SD. The scanning lines GL are electrically connected to the scanning line driving circuit GD. The backlight BL includes, for instance, a plurality of cold cathode tubes (not shown).

The reception unit TN is a tuner which selects a program signal that is received by an antenna AT. The signal that is received by the reception unit TN is supplied to the signal processing unit 10. The signal processing unit 10 includes a gamma correction unit 10A which executes gamma correction of an output signal immediately before the supplied signal is output to the liquid crystal display panel PNL.

The TV apparatus according to the present embodiment further includes a timer TM which counts a time in which the liquid crystal display device LCD is powered off. The controller CTR includes a determination unit 20 which determines whether the liquid crystal display device LCD is powered on. If the determination unit 20 determines that the liquid crystal display device LCD is powered on, the controller CTR acquires from the timer TM the time in which the liquid crystal display device LCD is powered off, and controls the gamma correction unit 10A in accordance with the acquired time. Thereby, correction is made to increase the brightness of an image that is displayed on the display area DYP, during a time T from power-on of the liquid crystal display device LCD.

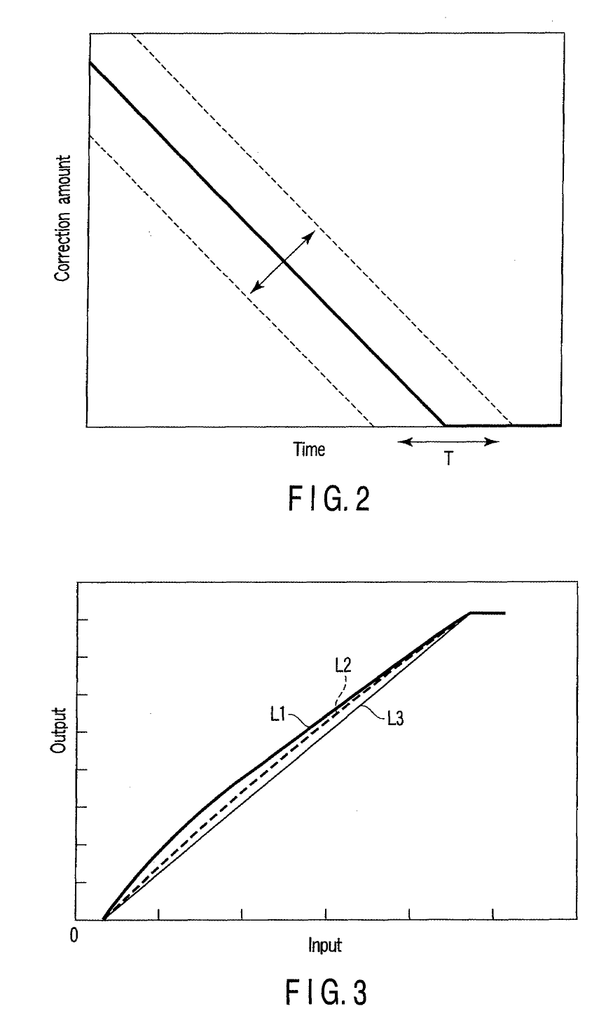

Specifically, in the TV apparatus according to the present embodiment, the controller CTR controls the gamma correction unit 10A to make correction, for example, in such a manner that the amount of gamma correction linearly decreases, as shown in FIG. 2, with the passing of time, during the time T from the power-on of the liquid crystal display device LCD.

At this time, for example, in the case of the liquid crystal display device LCD, the time from the power-on of the liquid crystal display device LCD to the obtaining of sufficient brightness varies in accordance with the temperature of the cold cathode tubes of the backlight BL.

Thus, in the TV apparatus of the present embodiment, the controller CTR varies the time T in which the gamma correction unit 10A is caused to make gamma correction, in accordance with the time acquired from the timer TM, in which the liquid crystal display device LCD is powered off.

Specifically, as the time during which the liquid crystal display device LCD is powered off is longer, the temperature of the cold cathode tubes of the backlight BL is lower, and the controller CTR increases the time T for making gamma correction. Conversely, as the time during which the liquid crystal display device LCD is powered off is shorter, the temperature of the cold cathode tubes of the backlight BL is higher, and the controller CTR decreases the time T for making gamma correction.

By making the gamma correction as described above, the relationship between an input signal and an output signal of the gamma correction unit 10A is set, as shown in FIG. 3, and the output signal, relative to the input signal to the gamma correction unit 10A, increases, as indicated by graph L1, immediately after power-on of the liquid crystal display device LCD. The amount of correction in the gamma correction unit 10A decreases during the time T. Thus, the output signal, relative to the input signal to the gamma correction unit 10A, gradually decreases as indicated by graph L2, compared to graph L1. After the passing of the time T, as indicated by graph L3, the amount of correction in the gamma correction unit 10A becomes zero.

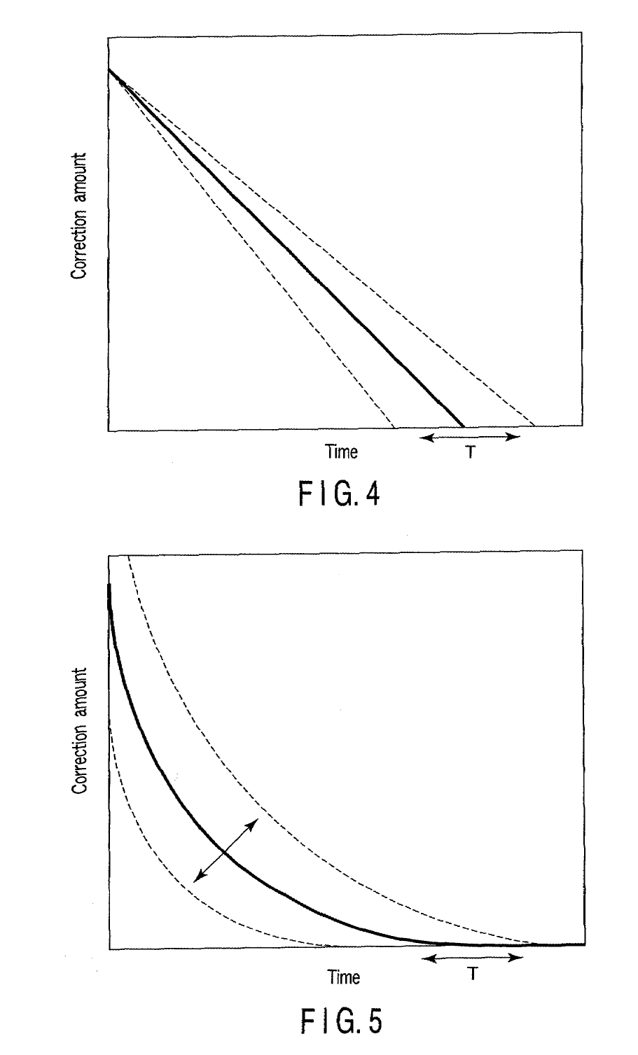

Alternatively, the amount of correction at the time of performing gamma correction may be varied, for example, as shown in FIG. 4 and FIG. 5, with the passing of time. Specifically, as shown in FIG. 4, the initial amount of correction is set at a fixed value, and the time T for performing gamma correction may be varied in accordance with the time during which the liquid crystal display device LCD is powered off. Besides, as shown in FIG. 5, the amount of correction may be varied in a curved shape. In this case, too, the time T for performing gamma correction may be varied in accordance with the time during which the liquid crystal display device LCD is powered off.

By performing correction as described above, the brightness of the image displayed on the display area DYP is corrected to be increased during the time T from the power-on of the liquid crystal display device LCD. Thus, even if the brightness of the backlight BL is not sufficient, it is possible to avoid such a situation that the image that is displayed is dark and not easily visible.

A signal, which is supplied from the signal processing unit 10 to the liquid crystal display device LCD, is delivered to the signal line driving circuit SD of the liquid crystal display device LCD. The scanning line driving circuit GD and the signal line driving circuit SD are controlled by the controller CTR, and image signals that are output from the signal line driving circuit SD are written in the display pixels PX which are selected by the scanning line GL that is successively selected by the scanning line driving circuit GD.

Therefore, it is possible to provide a TV apparatus wherein the controller CTR controls the gamma correction unit 10A, as described above, and an image with sufficient brightness can be displayed on the display unit during the predetermined time period from power-on of the display unit. According to the TV apparatus of the present embodiment, since the brightness of the backlight BL is not varied, the above-descried advantage can easily be obtained at low cost, without using an expensive backlight BL.

Next, an image processing method in the above-described TV apparatus is described. To begin with, if the controller CTR determines that the liquid crystal display device LCD is powered on (step STA1), the controller CTR acquires, from the timer TM, the time during which the liquid crystal display device LCD is powered off (step STA2).

The controller CTR controls the gamma correction unit 10A in accordance with the time acquired from the timer TM. Specifically, the controller CTR determines the time T for performing gamma correction, in accordance with the time acquired from the timer TM (step STA3).

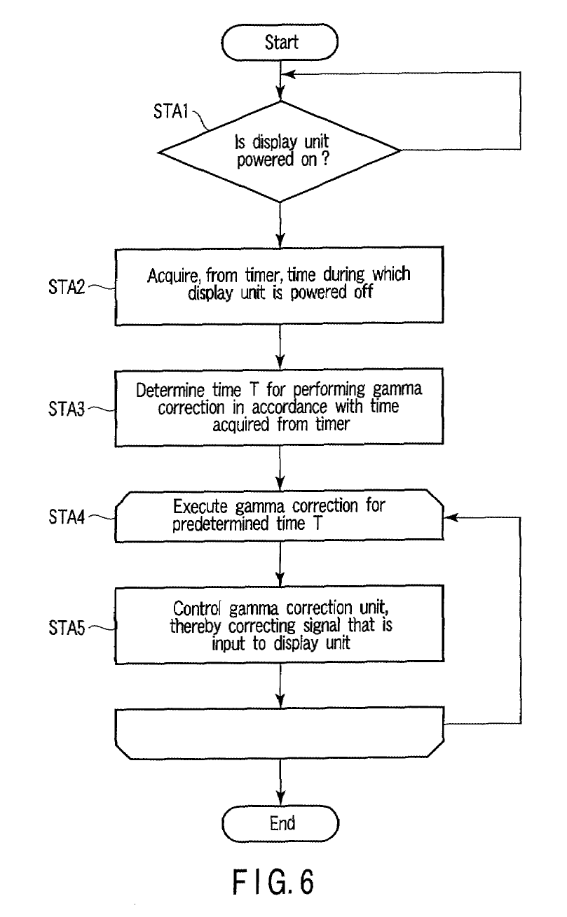

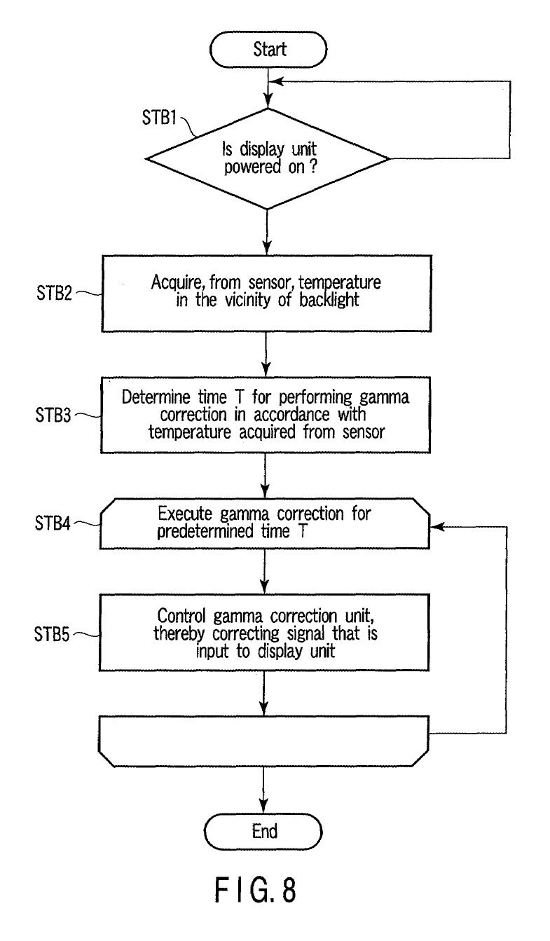

Subsequently, the controller CTR causes the gamma correction unit 10A to make gamma correction during the time T (step STA4). Specifically, the controller CTR controls the gamma correction unit 10A to correct the amount of gamma correction for the signal that is output to the liquid crystal display device LCD, for example, as shown in FIG. 2 (step STA5). In FIG. 6, a blank block is depicted as being subsequent to the block of Step STA5, and an arrow starting from the blank block and leading to the block of Step STA4 is depicted. This means that the correction processing based on the control by the gamma correction unit 10A is repeatedly executed until the end of the gamma correction processing. The same holds true for FIG. 8 to be described below.

As has been described above, when the liquid crystal display device LCD is powered on, the gamma correction unit 10A is caused to perform gamma correction for the predetermined time. It is thus possible to provide the image processing method for enabling the liquid crystal display device LCD to display an image with sufficient brightness even in a predetermined time period from power-on of the liquid crystal display device LCD.

Furthermore, the time T for performing the gamma correction at the time when the liquid crystal display device LCD is powered on is varied in accordance with the time during which the liquid crystal display device LCD is powered off. Thereby, the brightness of the image that is displayed can be corrected more effectively in the predetermined time period from the power-on of the liquid crystal display device LCD.

Next, a TV apparatus according to a second embodiment of the present invention is described with reference to the accompanying drawings. In the description below, the structural parts common to those of the TV apparatus of the above-described first embodiment are denoted by like reference numerals, and a description thereof is omitted.

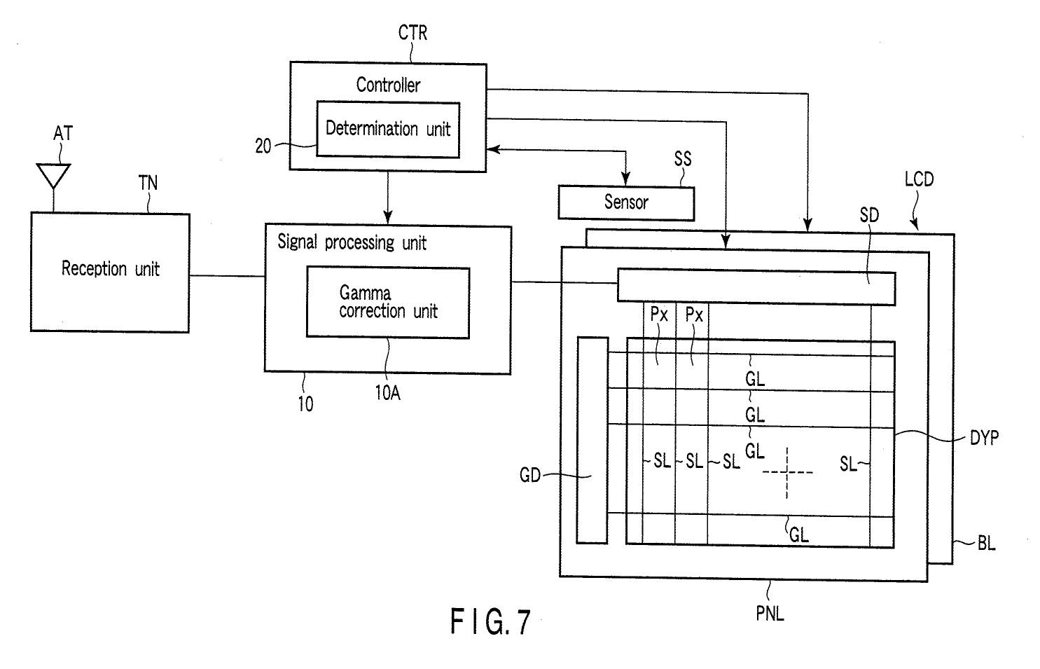

As shown in FIG. 7, the TV apparatus according to the present embodiment includes a sensor SS which is disposed near the liquid crystal display device LCD. The sensor SS measures the temperature in the vicinity of the cold cathode tubes of the backlight BL.

Specifically, an image processing method in the above-described TV apparatus is described. To begin with, if the controller CTR determines that the liquid crystal display device LCD is powered on (step STB1), the controller CTR acquires, from the sensor SS, the temperature in the vicinity of the cold cathode tubes of the backlight BL (step STB2).

The controller CTR controls the gamma correction unit 10A in accordance with the temperature acquired from the sensor SS. Specifically, the controller CTR determines a time T for performing gamma correction, in accordance with the temperature acquired from the sensor SS (step STB3).

Subsequently, the controller CTR causes the gamma correction unit 10A to make gamma correction during the time T (step STB4). Specifically, the controller CTR controls the gamma correction unit 10A to correct the amount of gamma correction for the signal that is output to the liquid crystal display device LCD, for example, as shown in FIG. 2 (step STB5).

As has been described above, when the liquid crystal display device LCD is powered on, the gamma correction unit 10A is caused to perform gamma correction for the predetermined time. It is thus possible to provide the image processing method for enabling the liquid crystal display device LCD to display an image with sufficient brightness even in a predetermined time period from power-on of the liquid crystal display device LCD.

Furthermore, the time T for performing the gamma correction at the time when the liquid crystal display device LCD is powered on is varied in accordance with the temperature in the vicinity of the cold cathode tubes of the backlight BL. Thereby, the brightness of the image that is displayed can be corrected more effectively in the predetermined time period from the power-on of the liquid crystal display device LCD.

The present invention is not limited directly to the above-described embodiments. In practice, the structural elements can be modified and embodied without departing from the spirit of the invention. For example, the TV apparatus according to each of the above-described embodiments includes the liquid crystal display device as the display unit. However, the display unit is not limited to the liquid crystal display device, and may be a CRT display device or a plasma display device, for instance.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processing apparatus comprising:
reception means for selectively receiving a signal;
signal processing means for processing the signal that is output from the reception means, and outputting the signal to display means; and
control means for controlling the signal processing means,
wherein the control means includes determination means for determining whether the display means is powered on, and
the signal processing means includes correction means for correcting brightness of an image, which is displayed on the display means, for a predetermined time from when the determination means determines that the display means is powered on.

2. The image processing apparatus according to claim 1, further comprising a timer which counts a time during which the display means is powered off,
wherein the control means includes means for setting, in accordance with the time counted by the timer, the predetermined time for correcting the brightness of the image which is displayed upon power-on of the display means.

3. The image processing apparatus according to claim 1, wherein the display means includes a liquid crystal display panel and illumination means for illuminating the liquid crystal display panel,
the image processing apparatus further comprises a sensor which measures a temperature of the illumination means, and
the control means includes means for setting, in accordance with a value measured by the sensor, the predetermined time for correcting the brightness of the image which is displayed upon power-on of the display means.

4. An image processing method comprising:
a determination step of determining whether display means is powered on; and
a correction step of correcting brightness of an image, which is displayed on the display means, for a predetermined time from when the display means is powered on.

5. The image processing method according to claim 4, wherein the correction step includes:
a time acquisition step of acquiring, from a timer, a time during which the display means is powered off; and
a correction time setting step of setting, in accordance with the time acquired in the time acquisition step, the predetermined time for correcting the brightness of the image which is displayed on the display means upon power-on of the display means.

6. The image processing method according to claim 4, wherein the correction step includes:
a temperature acquisition step of acquiring, from a sensor, a temperature in a vicinity of the display means; and
a correction time setting step of setting, in accordance with the temperature acquired in the temperature acquisition step, the predetermined time for correcting the brightness of the image which is displayed on the display means.

7. A TV apparatus comprising:
display means;
reception means for selectively receiving a signal;
signal processing means for processing the signal that is output from the reception means, and outputting the signal to the display means; and
control means for controlling the signal processing means,
wherein the control means includes determination means for determining whether the display means is powered on, and
the signal processing means includes correction means for correcting brightness of an image, which is displayed on the display means, for a predetermined time from when the determination means determines that the display means is powered on.
